(19) United States
(12) Patent Application Publication
(10) Pub. No.: US 2015/0356700 A1
(43) Pub. Date: Dec. 10, 2015

(54) EDUCATION MANAGEMENT SYSTEM AND METHOD FOR ENABLING CREDITS TO BE ADMITTED BASED ON TALENTS AND CAREERS

(71) Applicant: Ki Chul HAM, Chungcheongnam-do (KR)

(72) Inventor: Ki Chul HAM, Chungcheongnam-do (KR)

(21) Appl. No.: 14/763,637

(22) PCT Filed: Dec. 10, 2013
(86) PCT No.: PCT/KR2013/011422

§ 371 Date: Jul. 27, 2015

(30) Foreign Application Priority Data
Jan. 28, 2013 (KR) 10-2013-0009139
Feb. 8, 2013 (KR) 10-2013-0014368
Oct. 8, 2013 (KR) 10-2013-0120102
Oct. 25, 2013 (KR) 10-2013-0127912

(51) Int. Cl. G06Q 50/20; G06Q 10/10

(52) U.S. Cl. CPC G06Q 50/2057; G06Q 10/10

(57) ABSTRACT

Provided are an education management system and an education management method which enable talents and careers to be admitted as credits, the education management system connected to a user terminal and an authentication server through a network, including: a receiving unit configured to receive career data from the user terminal; a career assessment unit configured to assess career matters included in the career data on the basis of predetermined standards; and a credit-awarding unit configured to give credits corresponding to grades resulting from career assessment for a student's major to the career matters.

### BACKGROUND OF THE INVENTION

1. Field of the Invention

The present invention relates to an education management system and an education management method that enable credits to be admitted based on talents or carriers and also enable credits to be admitted based on both talents and carriers.

2. Description of the Related Arts

Knowledge possessed by the people becomes a source of competitiveness in knowledge-based society. Accordingly, the development and effective utilization of human resources are very important in terms of the competitiveness of countries or companies.

Recently, large numbers of companies are converting their organization systems into the strategy of growth on the basis of human resources, in which knowledge and technologies are accumulated, instead of the strategy of growth on the basis of the input of capital or a labor force which is faced with a limit.

However, an education management system which has been currently used at a university or a graduate school fails to support the development or effective utilization of human resources for affiliated students.

Although some universities have promoted to develop human resources using an education management method on the basis of on-site practical education, since various talents or careers possessed by students have not been basically considered, it is disadvantageous in that a utilization scope thereof is substantially limited in developing or utilizing human resources.

Meanwhile, various online education systems have been recently suggested due to the generation of a case where it is difficult to take an offline course due to geographical and time factors, and the like. This online education system has been specialized based on communication or connection-related technologies accompanied with online education, and in this regard, in order to ensure the evaluation of attendance and absence evaluation or the internal stability of educational courses, methods for surveillance or assessment have been additionally suggested so that attendees can take substantive courses.

As one example, Korean Patent No. 10-0610276 entitled “Internet Lecture System and Lecture Method using the Same” discloses a system that provides an internet lecture through real-time chatting between a lecturer and a student and enables the student to repeatedly attend the lecture to which the student has listened, the system including: a user terminal; a main server configured to convert lecture contents into a video and audio data stream and to store it; a web server configured to transmit the data stream stored in the main server to the user terminal and to provide a memorandum for enabling the student to input the memo through the user terminal; an SMS (Short Message Service) conversion server configured to convert the memo displayed on the memorandum into SMS data; a portable terminal of each of the lecturer and the student who attend the lecture through the user terminal; and a memo transmission server configured to transmit the SMS data converted by the SMS conversion server to at least one portable terminal.

As such, the conventional online educational system is only intended to have similar effects to those of an offline educational system by improving learning efficiency or enabling substantive lessons to be performed, but fails to reflect students' talents or careers.

Furthermore, Korean Patent Laid-Open Publication No. 10-2007-0087839 discloses a system for managing e-classes and a method of evaluating grades, the system including: an input/output means; a recognizing/recognized means; a grade evaluation system; an educational administration system; a lecture contents supporting system; an information analysis system; an on-line interactive system; and an information input and output system. However, the conventional system and method for online educational management are focused on only the aspects of grade evaluation and education management, and do not still reflect student's talents or careers.

As described above, in the conventional education management-related system, since students' talents or careers are not reflected or considered, the system has a limit that it cannot be substantially utilized for effective development or utilization of human resources.

### SUMMARY OF THE INVENTION

An aspect of the present invention provides an education management system that is useful for development and effective utilization of human resources by enabling a student's talents or careers to be admitted.

Another aspect of the present invention provides an education management method that is useful for the development and effective utilization of human resources by enabling a student's talents or careers to be admitted as credits by going through a prescribed authentication procedure.

A further aspect of the present invention provides an education management system that enables students to accumulate knowledge and obtain a degree regardless of a place to study by enabling the students to attend a lecture and to acquire knowledge possessed by university professors at a desired place anywhere and anytime rather than a specific place.

In other words, yet another aspect of the present invention provides an education management system and method that enable careers except for school classes to be incorporated into a system for the completion of online education and to be linked with credits required for the obtaining of a degree by evaluating the careers pursuant to predetermined rules and authenticating the careers, which was not attempted in a conventional online or offline education system and method.

Still another aspect of the present invention provides an education management system and method that can be easily and variously approached by the people who do not enter university, need a degree, or would like to acquire a lot of knowledge, can be utilized as a space capable of satisfying the people's various cultural desires, can be a reference library where university or graduate school students can faithfully study, and can perform a role as a platform for initiating others into a person's talents and sharing knowledge.

Still another aspect of the present invention provides an education management system and method that enable various functional groups such as associations existing in the society except for career assessment to participate in a teaching area, and enable the organizations of company units to participate in the teaching area and in courses as themselves, thereby allowing to take courses based on links between schools and industry.

Still another aspect of the present invention provides an education management system and an education management method that enable credits to be admitted on the basis of talents and careers in an alternative university form.

According to an aspect of the present invention, there is provided an education management system for enabling credits to be admitted based on talents and careers (hereinafter briefly referred to as “the education management system”) which is connected to a user terminal via a network to enable the careers and talents to be admitted as the credits, the system including: a receiving unit for receiving career data from the user terminal; a career assessment unit for assessing career matters included in the career data on the basis of predetermined standards; and a credit-awarding unit for giving credits corresponding to grades resulting from career assessment for a student's major to the career matters.

The education management system may further include a certificate authority linkage unit for inquiring to a relevant certificate authority as to whether or not the career matters included in the career data are true and for receiving a reply as to whether or not the career matters are true from the relevant certificate authority.

The credit-awarding unit may give predetermined credits for working hours included in the career matters being beyond a constant standard regarding major-related businesses and carried out at a company, or for the completion hours of education being beyond a constant standard and carried out in a predetermined educational institution.

According to another aspect of the present invention, there is provided an education management method for enabling credits to be admitted based on talents and careers (hereinafter briefly referred to as “the education management method”), which is carried out by an education management system connected to a user terminal via a network to enable the careers and talents to be admitted as the credits, the method including: receiving a student's career data from a user terminal; assessing career matters included in the career data on the basis of predetermined standards; and giving credits corresponding to grades resulting from the career assessment for the student's major to the career matters when the career matters are admitted.

The education management method may further include inquiring to a relevant certificate authority as to whether or not the career matters included in the career data are true before performing the career assessment; and receiving a reply from the certificate authority as to whether not the career matters are true.

The giving of the credits may include providing predetermined credits for working hours included in the career matters and being beyond a constant standard regarding major-related businesses and carried out at a company, or for the completion hours of education being beyond a constant standard and carried out in a predetermined educational institution.

According to a further aspect of the present invention, there is provided an education management system for enabling credits to be admitted based on talents and careers, which is connected to a user terminal via a network to enable the careers and talents to be admitted as the credits, the system including: a first receiving unit for receiving a student's talent-related data from a user terminal; an associated authority linkage unit for inquiring to an associated authority as to whether or not talent matters included in the talent-related data are true and for receiving a reply as to whether or not the talent matters are true from the associated authority; and a talent assessment unit for assessing the talent matters on the basis of predetermined standards; a credit-awarding unit for giving credits corresponding to grades resulting from the talent assessment for the student's major to the talent matters when the talent matters are admitted.

The education management system may further include: a second receiving unit for receiving a student's career data from the user terminal; a career assessment unit for assessing career matters in the career data on the basis of predetermined standards; and a credit-awarding unit configured to give credits corresponding to grades resulting from the career assessment for the student's major to the career matters when the career matters are admitted.

The education management system may further include a certificate authority linkage unit for inquiring to a relevant certificate authority as to whether or not the career matters included in the career data are true and for receiving a reply as to whether or not the career matter are true from the relevant certificate authority.

The credit-awarding unit may give predetermined credits for talent donation hours registered in an associated authority or may give predetermined credits for working hours included in the career matters and being beyond a constant standard regarding major-related businesses carried out at a company or for the completion hours of education being beyond a constant standard carried out in a predetermined educational institution.

When the credits obtained from at least one of the talent assessment and the career assessment are standard credits or more than 60% of credits for graduation, the credit-awarding unit or the education management system may record in a relevant student's database that the relevant student can acquire a degree based on credits resulting from the recognition of talents, credits resulting from the recognition of careers, or credits resulting from the recognition of both talents and careers. Here, the recoding on the acquiring of the degree based on the credits resulting from the recognition of talents, the credits resulting from the recognition of careers, or the credits resulting from the recognition of both talents and careers may include ‘a bachelor of electronic engineering resulting the recognition of talents,’ ‘a bachelor of electronic engineering resulting the recognition of careers,’ ‘a bachelor of electronic engineering resulting the recognition of both talents and careers,’ ‘a master of electronic engineering resulting from the recognition of both talents and careers,’ ‘a bachelor of electronic engineering (the recognition of talents),’ ‘a master of electronic engineering (the design of a semiconductor) (being recognized as a career),’ and the like.

According to yet another aspect of the present invention, there is provided an education management method, which is carried out by an education management system connected to a user terminal via a network to enable careers and talents to be admitted as credits, the method including: receiving a student's talent-related data from the user terminal; inquiring to an associated authority as to whether or not talent matters included in the talent-related data are true; receiving a reply from the associated authority as to whether not the talent matters are true; assessing the talent matters on the basis of predetermined standards; and giving credits corresponding to grades resulting from the talent assessment for the student's major to the talent matters when the talent matters are admitted.

The education management method may further include: receiving the student's career data from the user terminal; assessing career matters included in the career data on the basis of the predetermined standards; and giving credits corresponding to grades resulting from the career assessment for the student's major to the career matters when the career matters are admitted.

The education management method may further include inquiring to a predetermined certificate authority as to whether or not the career matters included in the career data are true before assessing the career matters; and receiving a reply from the certificate authority as to whether not the career matters are true.

The giving of the credits may include giving predetermined credits for talent donation hours registered in the associated authority or may include giving predetermined credits for working hours included in the career matters being beyond a constant standard regarding major-related businesses and carried out at a company or for the completion hours of education being beyond a constant standard and carried out in a predetermined educational institution.

The talents or careers may mean a contribution rate to public welfare including voluntary services hours performed in a predetermined authority and the like, or a winning grade obtained through a predetermined contest.

The giving of the credits may include recording in the relevant student's database that the relevant student can acquire a degree based on credits resulting from the recognition of talents, credits resulting from the recognition of careers, or credits resulting from the recognition of both talents and careers when credits obtained from at least one of the talent assessment and the career assessment are standard credits or more than 60% of credits for graduation.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram showing an education management system for enabling credits to be admitted based on talents and careers (hereinafter briefly referred to as “the education management system”) according to one embodiment of the present invention;

FIG. 2 is a flow chart showing an education management method for enabling credits to be admitted based on talents and careers (hereinafter briefly referred to as “the education management method”), which can be applied to the education management system of FIG. 1;

FIG. 3 is a block diagram showing one example of an integrated education management system to which the education management system of FIG. 1 is applied;

FIG. 4 is a flow chart showing one example of an education management method which can be applied to the integrated education management system of FIG. 3;

FIG. 5 is a block diagram showing an education management system according to another embodiment of the present invention;

FIG. 6A and FIG. 6B are flow charts for an education management method which can be applied to the education management system of FIG. 5;

FIG. 7 is a block diagram showing an integrated education management system to which the education management system of FIG. 5 is applied;

FIG. 8 is a flow chart for the operation procedure of a talent classification server of FIG. 7;

FIG. 9 is a flow chart for the operation procedure of an associated authority classification server of FIG. 7;

FIG. 10 is a flow chart for the operation procedure of a company classification server of FIG. 7;

FIG. 11 is a flow chart for the operation procedure of a student classification server of FIG. 7; and

FIG. 12 is a flow chart for the operation procedure of an evaluation server of FIG. 7.

### DETAILED DESCRIPTION OF THE INVENTION

Hereinafter, embodiments of the present invention will be described in detail with reference to the accompanying drawings. In the following description, it is to be noted that, when the functions of conventional elements and the detailed description of elements related to the present invention may make the gist of the present invention unclear, a detailed description of those elements will be omitted. Furthermore, in order to clearly describe the present invention, parts unrelated to the description will be omitted from the drawings, and reference should now be made to the drawings, in which the same reference numerals are used throughout the different drawings to designate the same or similar components.

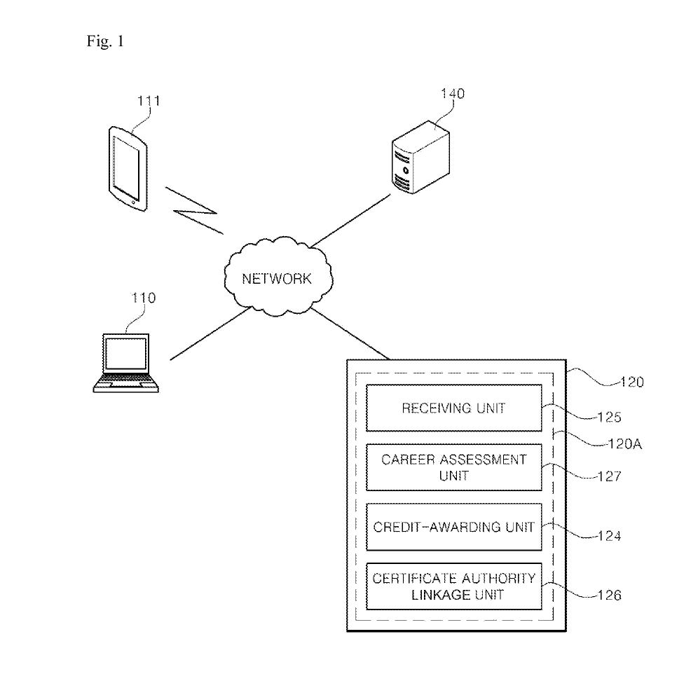

FIG. 1 is a block diagram showing an education management system for enabling credits to be admitted based on talents and careers according to one embodiment of the present invention.

Referring to FIG. 1, an education management system for enabling credits to be admitted based on talents and careers 120 according to the present embodiment (hereinafter briefly referred to as “the education management system”) is mounted to a school server 100 or is connected to user terminals 110, 111 and an authentication server 140 via a network as an education management server linked with the school server 100, thereby enabling careers to be admitted as credits. To do so, the education management system 120 includes: a receiving unit 125 configured to receive a student's career data from the user terminals 110, 111; a career assessment unit 127 configured to assess career matters included in the career data based on predetermined standards; and a credit-awarding unit 124 configured to give credits corresponding to grades resulting from the carrier assessment for the student's major to the career matters when the career matters are acceptable.

Also, the education management system 120 may further include a certificate authority linkage unit 126 configured to inquire to a relevant certificate authority as to whether or not the career matters included in the career data are true and to receive a reply as to whether or not the career matters are true from the relevant certificate authority.

The receiving unit 125 is a means configured to receive the student' career data from the user terminals 110, 111 through the network or a constitution unit for performing a function corresponding to the means. The receiving unit 125 may include a communication module of a predetermined communication method, and may provide a user interface for inputting the career data into the user terminals 110, 111.

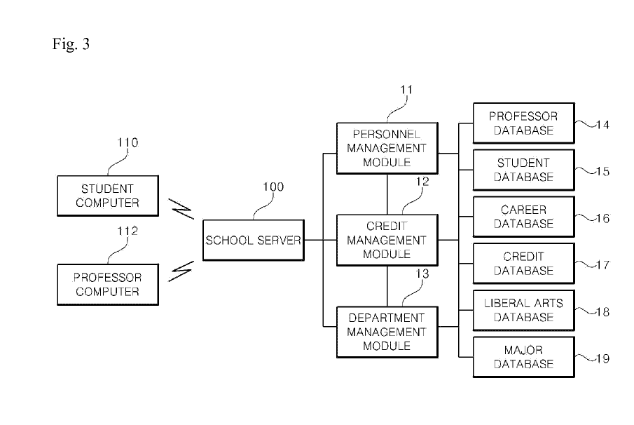

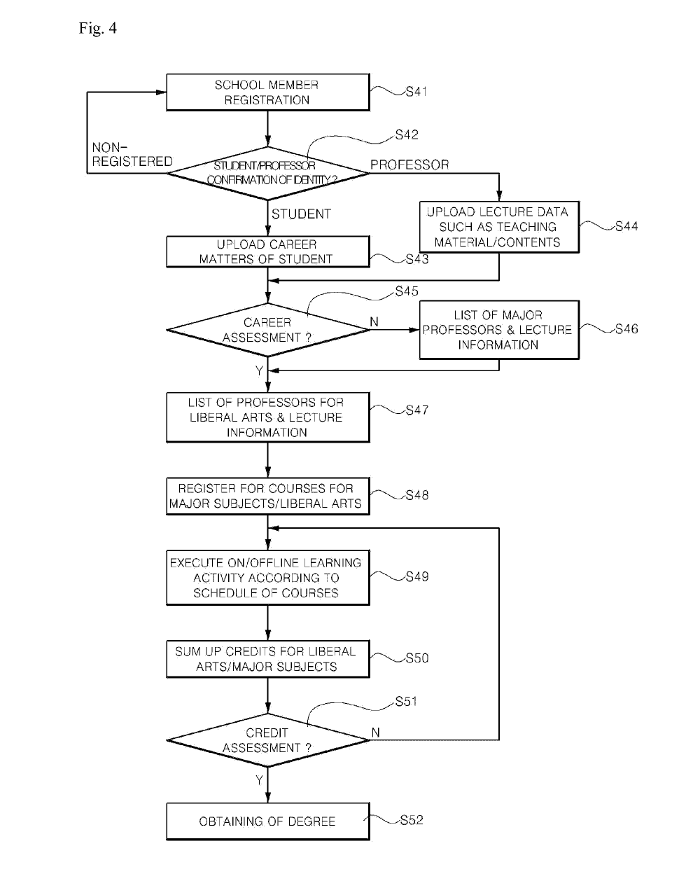

The career assessment unit 127 may assess the student's career matters confirmed through the certificate authority 140 according to pre-stored standards (standards for evaluation) in a storage unit or a data base. The career assessment unit 127 will be more specifically described in the sections for the procedures of career assessment of FIGS. 3 and 4.

The credit-awarding unit 124 may give predetermined credits for working hours included in the career matters being beyond a constant standard regarding major-related businesses and carried out at a company or for the completion hours of education being beyond a constant standard and carried out in a predetermined educational institution.

The credit-awarding unit 124 may be implemented of a means for providing credits for the student's major using a method of updating the student's education record information stored in a storage unit or a data base, or a constitution unit for performing a function corresponding to the means. Also, the credit-awarding unit 124 may be implemented of some functional units in an education management module (see reference numeral 12 of FIG. 3) of the education management system 120 or a constitution unit for substantially performing the same function as that of the functions units.

The certificate authority linkage unit 126 may be connected to the certificate authority 140 through the network, and may be implemented of a means for inquiring to the certificate authority 140 as to whether or not the career matters are true and for receiving a reply thereto, or a constitution part for performing a function corresponding to the means. The certificate authority 140 may include a server of the Automobile Technical Association, a server of the Hairdressers Association and the like.

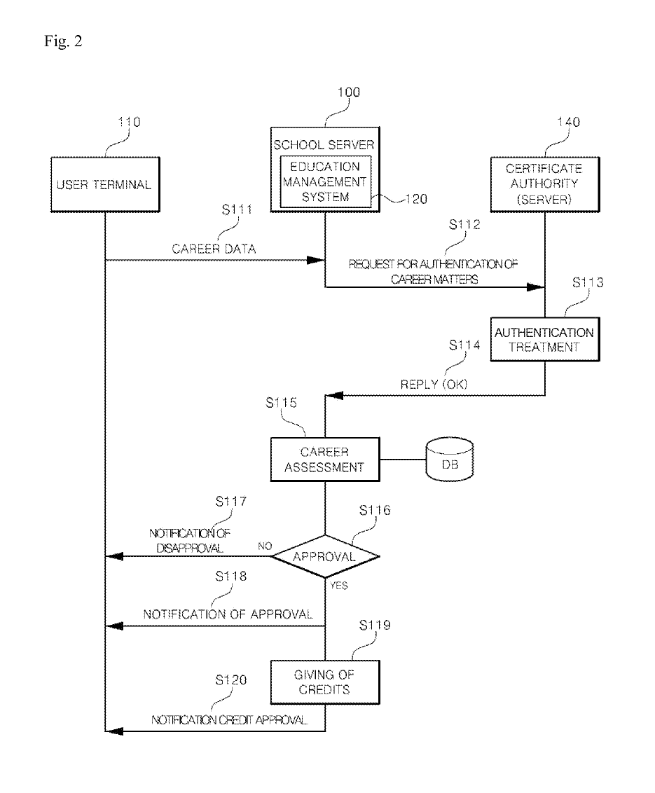

FIG. 2 is a flow chart showing an education management method for enabling credits to be admitted based on talents and careers (hereinafter briefly referred to as “the education management method”) which can be applied to the education management system of FIG. 1.

Referring to FIG. 2, the education management method according to the present embodiment may be performed such that careers are admitted as credits through the education management system installed at or linked with the school server 100 or connected to the user terminal through a network.

More specifically, the education management system 120 first receives a student's career data from the user terminal 110 or 111 S111.

Next, the education management system 120 may assess career matters included in the career data on the basis of predetermined standards S115.

Meanwhile, before assessing the career matters S115, the education management system 120 may further include inquiring to the certificate authority 140 as to whether or not the career matters included in the career data are true S112, handling authentication of the certificate authority 140 S113 and receiving a reply from the certificate authority 140 as to whether or not the career matters are true S114.

As a result of assessing the career matters S116, when the career matters are not admitted, the education management system 120 may transmit a notification on disapproval of the career matters as credits to the user terminal 110 S117. Meanwhile, when the career matters are admitted, the education management system 120 may transmit a notification on approval of the career matters as credits to the user terminal 110 S118.

Next, the education management system 120 may give credits corresponding to grades resulting from the career assessment for the student's major to the career matters S119. Then, the education management system 120 may notify a result of recognition of the career matters as credits or a result of the given credits to the user terminal 110 S120.

FIG. 3 is a block diagram showing one example of an integrated education management system to which the education management system of FIG. 1 is applied. Referring to FIG. 3, an integrated education management system according to the present embodiment is configured such that the school server 100 is connected to a school computer 110, and a professor computer 112 through a network. The school server 100 includes a personal management module 11, a credit management module 12 and a department management module 13.

The personal management module 11 may include a student database 15 and a professor database 14, the credit management module 12 may include a career database 16 and a credit database 17, and the department management module 13 may include a liberal arts database 18 and a major database 19. Here, the modules and the data bases may be connected to each other.

The school server 100 may connect the professor computer 112 of faculty members and the school computer 110 of students through a network, may provide a web site of the school server, may confirm and authenticate the identity of teaching staffs and students by receiving the request of authorization provided from the professor computer 112 or the student computer 110 connected to the school server 100 through the personal management module 11, and provide lecture data including teaching materials and multimedia video contents through the education management module 13. Also, and the school server 100 may manage records as to whether or not students take the online and offline lectures of established departments and established lectures, enable the student's career matters to be admitted as major credits through the credit management module 12, and give or manage liberal art credits and major credits necessary for obtaining a degree.

Explaining more specifically it, the personal management module 11 may authenticate the identity of the teaching staffs through the professor database 14, may store confirmation records of the identity and a list of the teaching staffs in the professor database 14, complete the students' course registration through the student database 15, perform confirmation of the identity, and store the confirmation records of the identity and a list of the students in the student database 15.

The department management module 13 may provide lecture data including teaching materials and multimedia video contents to the students through the liberal arts database 18 and the major database 19, and may also store the lecture data including teaching materials and multimedia video contents provided by professors in the liberal art database 18 and the major database 19.

The credit management module 12 may convert the student's career matters into major credits through the career data base 16, give grades immediately for the students' academic performances through the credit database 17, collect all grade statistics, and store academic performance grades in a current level in the credit database 17.

The student's career matters may be admitted as major credits when the career matters meet the standards for career assessment. That is, predetermined jobs among career matters relating to a business license, a duty paid certificate, a withholding receipt, a certificate of working experience, a copy of a certificate of competency, competition awards, a certificate of the working experience of a group and an association and the like or predetermined working hours performed in a company are admitted as credits for specific liberal arts or major credits of a relevant department. For example, in the case of the department of car maintenance, 40 hours related to car maintenance careers are admitted as 1 credit, and when 25 or more credits are obtained, it is admitted to complete the first form. The career matters of predetermined procedures such as separation and attachment and basic trouble diagnosis, the understanding of an engine and system and trouble diagnosis thereof, the understanding and full knowledge of control devices for each system, single diagnosis according to a trouble phenomenon, repair and diagnosis for a difficult trouble, the full knowledge of customer service procedures and leading procedures and the like among maintenance procedures may be converted into credits.

Also, in the case of a beauty care related department, 40 hours of beauty care related careers are admitted as 1 credit, and when 25 or more credits are obtained, it is admitted to complete the first form. The career matters of predetermined procedures such as the procedure of customer services (arrangement of information on customers, measurement for scalp and hair), the procedure of professionalism (scaling, hygienic conditions, dress, a skill level, and a posture), the procedure of systematization (flexibility, connectivity, consideration, dry, nutrition supply, and treatment), the procedure of a master (the handling of customer reception, the master of scaling, massages, and skilled handling) may be converted into credits.

Also, in the case of a noncommissioned officer department, soldier careers are admitted as credits, and 40 hours of the solder careers are admitted as 1 credit, so, when 25 or more credits are obtained, it is admitted to complete the first form. Also, as the solider careers are admitted as credits for a major field, when the solider careers are related to transportation, the solider careers may be admitted as credits for the major field of the department of car maintenance, and when the solider careers are related to communication, the solider careers may be admitted as credits for the major field of the department of electricity or electronics.

As such, the major credits are obtained based on careers, and insufficient major credits and liberal art credits are supplemented by completing courses for a major and liberal arts which are established in the school server 100, so when the acquiring of major credits and credits for liberal arts necessary for obtaining a degree is completed, the school server 100 enables the student to obtain a degree of the relevant department.

That is, in the education management system according to the present embodiment, among credits for graduation (for example, 140 credits), when a student who has obtained credits being beyond constant credits and based on credits obtained by the recognition of his or her careers, a degree granted for the student may be recorded in a form such as ‘a bachelor of electronic engineering (the recognition of careers),’ ‘a bachelor of electronic engineering resulting from the recognition of careers,’ ‘a master of electronic engineering resulting from the recognition of careers,’ ‘a master of electronic engineering (the design of a semiconductor) (the recognition of careers)’ and the like.

FIG. 4 is a flow chart showing one example of an education management method which can be applied to the integrated education management system of FIG. 3. Referring to FIG. 4, the education management method according to the present embodiment may include: a student or a professor connecting to the school server 100 through the school computer 110 or the professor computer 112 for performing the registration as a school member S41; confirming an identity of the student or the professor S42; uploading career data when a connector is the student S43; uploading lecture data including teaching materials and multimedia video contents when a connector is the professor S44; assessing the career matters on the basis of the student's career data S45; providing the list of teaching staffs for major subjects and lecture information when major credits are less than a predetermined level S46; providing the list of teaching staffs for liberal arts and lecture information when major credits are more than a predetermined level S47; the student registering courses for liberal arts or major subjects S48; carrying out online and offline learning activities according to the schedule of the courses or evaluating learning grades S49; totaling up credits for the liberal arts and credits for the major subjects S50; evaluating the credits (the assessment of credits) as to whether or not the credits are more than predetermined credits S51; granting a degree when the credits are more than the predetermined credits, thereby enabling the student to obtain the degree S52. The education management method according to the present embodiment will be hereinafter described in more detail.

First, when a student or a professor connects to the school server 100 through a network of the school computer 110 or the professor computer and performs the registration of a school member by uploading personal data for the confirmation of his or her identity, the integrated education management system or the education management system 120 stores the personal data for the confirmation of the identity of the student or the professor in the school database 15 and the professor database 14, and authenticates the registration of the school member of the student or the professor S41.

Next, when the student or the professor connects to the school server 100 through the school computer 110 or the professor computer 112 and logs on thereto, the education management system 120 performs the confirmation of his or her identity using data of the school database 15 or the professor database 14 through the personal management module 11. When the student or the professor is not a school member, the education management system 120 moves on to the step of registering as the school member S41, and when the student or the professor is a school member, the education management system 120 moves on to the next step S42.

In step S42 above, when a registered member is the student, the education management system 120 requests the student's career data. When the career data requested by the education management system 120 is uploaded from the student computer 110, the education management system 120 stores the student's career data in the career database 16 S43.

Here, the career data requested by the education management system (120) refers to information or electronic documents capable of certifying careers such as a business license, a duty paid certificate, a withholding receipt, a certificate of working experience, a copy of a certificate of competency, competition awards, and a certificate of the working experience of a relevant group and association.

In step S42 above, when a registered member is the professor, the education management system 120 is liked with the school server 100 to request to the professor to provide lecture data including teaching materials and multimedia video contents. When the lecture data requested by the education management system 120 is uploaded from the professor computer 112, the education management system 120 stores the professor's lecture data including teaching materials and multimedia video contents in the liberal art database 18 and the major database 19 S44.

Next, the education management system 120 performs the assessment of careers based on the student's career data stored in the career database 16 through the credit management module 12 to enable the student's career matters to be admitted as major credits, stores the major credits in the credit database 17, and moves to each next step S45.

Here, the assessment of careers in step S45 above may be intended to admit the student's career matter as predetermined credits, and may be carried out in such a manner that the career matters are admitted as credits according to predetermined standards or standards for recognition of the certificate authority.

In step S45 above, even after the career matters have been admitted as credits, when the major credits are less than a level, the education management system 120 extracts data of the professor database 14 and the major database 19 through the education management module 13 and provides the list of teaching staffs for major subjects and lecture information to the student computer 110 so as to proceed with next steps S46. Also, in step S45 above, after the career matters have been admitted as credits, when major credits are more than a level, the education management system 120 extracts data of the professor database 14 and the liberal art database 18 through the education management module 13 and provides the list of teaching staffs for liberal arts and lecture information to the student computer 110 S47.

At this time, the student can register for courses regarding liberal arts and major subjects necessary for the student after reviewing the list of teaching staffs for liberal arts and major subjects and lecture information provided from the school server 100 to the school computer 110. Upon the registration for the courses, the school server 100 stores the details of the registration for the courses in the credit database 17 through the credit management module 12 S48.

The student connects to the school server 100 through the school computer 110 and learns on/offline from lecture data including teaching materials and multimedia video contents provided through the liberal art database 18 or the major database 19 according to the schedule of the courses using the major management module 13 by the school server 100 so as to perform learning activity or so as to be evaluated on learning grades. At this time, the school server 100 stores the student's attendance matter and learning grade in the credit management database 17 through the credit management module 12 S49.

Furthermore, the school server 100 stores the sum of credits of liberal arts and major subjects in the credit management database 17 through the credit management module 12 S50.

The school server 100 judges whether or not credits are more than the standard credits by performing credit assessment based on the data of the credit database 17 through the credit management module 12. As the result of judgment, when the credits are less than the standard credits, the school server 100 proceeds with step S49 above again, and when the credits are more than the standard credits, the school server 100 proceeds with a next step S51. That is, when the completed credits are more than the standard credits, a degree is granted so that the attendee can obtain the degree S52.

As such, the education management method according to the present embodiment may enable careers to be admitted as credits, provide interactional real-time learning and school affair management using a lot of information on a network having time saving, and without constraints of time and space, enable students to select desired lecture contents anytime and anywhere and desired professors who give lectures, allow convenience which enables students to request their learning grades immediately, and enable the students to acquire their degrees by completing credits required for the degrees through their careers.

Meanwhile, according to one embodiment of the present invention, the education management system enables the grades of predetermined games for which a player wins an award in a local contest, a national contest, an international contest and the like to be admitted as careers or talents. In this case, scoring of the winning records is performed according to predetermined standards, and when the winning records are more than predetermined grades, the winning records may be admitted as major credits corresponding to the predetermined games.

Also, the education management system according to the present embodiment may be implemented such that a social contribution ratio for predetermined items such as a volunteer activity and the like is admitted as careers or talents. In such a case, the social contribution ratio may be admitted as major credits corresponding to a predetermined department or a major subject.

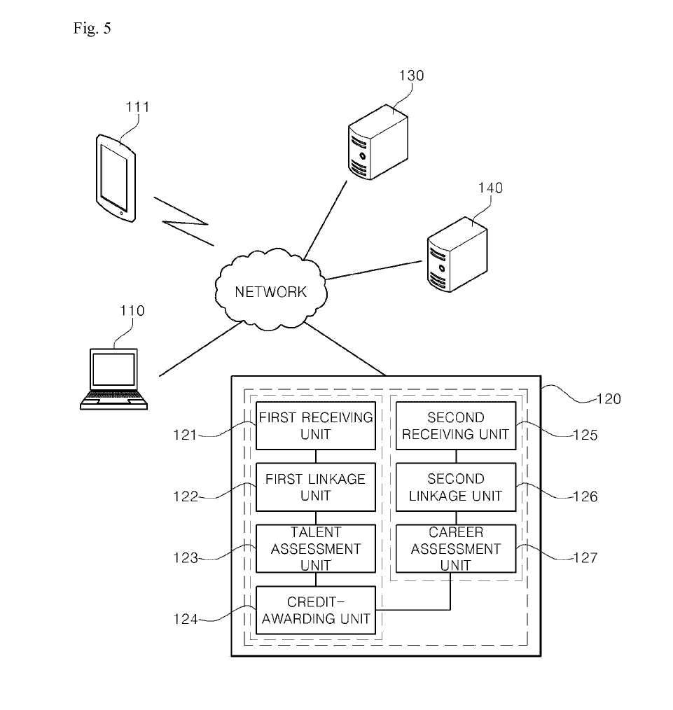

FIG. 5 is a block diagram showing an education management system according to another embodiment of the present invention;

Referring to FIG. 5, the education management system 120 according to the present embodiment for enabling credits to be admitted based on talents and careers which is connected to a user terminal, the associated authority (server) and the certificate authority (server) via a network to enable the careers and talents to be admitted as the credits, the system including: a first receiving unit configured to receive a student's talent-related data from the user terminals 110, 111; a relevant authority linkage unit 122 configured to inquire to a relevant authority 130 as to whether or not the talent matters included in the talent data are true and to receive a reply as to whether or not the talent matters are true from the relevant authority 130; and a talent assessment unit 123 configured to evaluate talents on the basis of a predetermined standard; a credit-awarding unit 124 configured to give credits corresponding to a score resulting the assessment of talent matters regarding his or her major when talent matters are admitted.

Also, the education management system 120 may further include: a second receiving unit 125 configured to receive the student's career data from the user terminals 110, 111; the career assessment unit 127 configured to evaluate career matters in the career data on the basis of the predetermined standards. Here, the credit-awarding unit 124 gives credits corresponding to a score resulting from the assessment of the career matters regarding the student's major when the career matters are admitted. Also, the education management system 120 may further include a certificate authority linkage unit 126 configured to inquire to a certificate authority 140 as to whether or not the career matters included in the career data are true and to receive a reply as to whether or not the career matter are true from the certificate authority 140. The aforesaid network includes a wire communication network, a wireless communication network or an integrated network thereof. The wireless communication network may include a local area network or a broadband communication network (3G, WiMAX, WiBro, LTE, LTE-A, a satellite network and the like).

The user terminal 110 is a computer terminal that is connected to the education management system 120 through the network so as to transmit and receive data with the education management system, and may include a smart phone 111 or i-pad such as an i-phone, a Galaxy note and the like, a smart pad such as a Galaxy tap and the like, a computer device such as a note book, a desktop computer and the like. Also, the user terminal may include a client terminal which is connected to a Claude server on the network so as to access a program and data of the server. As such, the user terminal may be implemented of a terminal which is accessible to a server device in various forms and using various communication methods (wire communication, wireless communication or a combination thereof).

Describing each constituent element of the aforesaid education management system more specifically, the first receiving unit 121 is a means for receiving the student' talent-related data from the user terminal 110 through the network and is a constitution unit for performing a function corresponding to the means. The first receiving unit 121 may include a communication module of a predetermined communication method and may provide a first user interface for inputting the talent-related data to the user terminal 110. Here, the talent-related data includes talent matters corresponding to predetermined talent donation items in the associated authority.

The second receiving unit 125 is a means for receiving the student's career data from the user terminal 110 through the network or a constitution unit for performing the function corresponding to the means. The second receiving unit 125 may include a second communication module of a predetermined communication method, and may provide a second user interface for inputting career data to the user terminal 110. Here, the career data includes career matters corresponding to predetermined careers or predetermined completion items of education in the certificate authority 140.

The associated authority linkage unit 122 is connected to the associated authority 130 through a network, is a means for inquiring to the associated authority as to whether or not the student's talent matters are true and receiving a reply as to whether or not the student's talent matters are true, and is implemented of a constitution unit for performing the function corresponding to the means. The associated authority 130 may include a mentoring management server and a talent donation foundation, a class management server after school, and the like.

The certificate authority linkage unit 126 is connected to the certificate authority 140 through a network, is a means is a means for inquiring to the certificate authority as to whether or not the student's career matters are true and receiving a reply thereto, and is implemented of a constitution unit for performing the function corresponding to the means. The certificate authority 140 may include a server of the Automobile Technical Association, a server of the Hairdressers Association and the like. Hereinafter, the associated authority linkage unit 122 will be briefly referred to as “a first linkage unit” and the certificate authority 126 will be briefly referred to as a second linkage unit.

The talent assessment unit 123 evaluates the student's talent matters confirmed through the associated authority 130 according to the pre-stored standards (a first standard) in a storage device or a database.

The career assessment unit 127 evaluates the student's career matters confirmed through the certificate authority 140 according to the pre-stored standards (a second standard) in a storage device or a database.

The credit-awarding unit 124 gives predetermined credits with regard to talent donation hours registered in the associated authority, and also provides predetermined credits with regard to working hours being beyond a predetermined standard for major-related businesses included in career matters and performed at a company or education completion hours being beyond a predetermined standard performed at a pre-designated education institution. The credit-awarding unit 124 may be implemented of a means for providing credits to the student's major in a method of updating the student's education recording information or a constitution unit for performing a function corresponding to the means. Also, the credit-awarding unit 124 may include some function units or constitution units in the education management server 73 of the management server.

The first receiving unit 121, the first linkage unit 122, the talent assessment unit 123 and the credit providing unit 124 correspond to a credit management unit for enabling the credits to be admitted on the basis of the talents. Furthermore, the second receiving unit 125, the second linkage unit 126, the career assessment unit 127 and the credit-awarding unit 124 correspond to an education management unit for enabling the credits to be admitted on the basis of the careers.

According to the present embodiment, there may be provided the education management system which enables credits to be admitted based on talents or careers, or which recognizes talents and careers-centered credits in an alternative university form or an alternative graduate school form which could not be found in the conventional education management system or an education management method capable of implementing a similar system to the conventional education management system.

For example, the education management system according to the present embodiment may be differentiated from the existing education management system by setting a rate of talent/career-based credits which should be necessarily obtained with regard to credits for graduation (for example, 140 credits) required at a major department of an university or a graduate school, or grades for the acquiring of a degree as more than about 60%. In such a case, remaining credits may be provided by credits resulting from taking courses for liberal arts, internet courses, minimum attendance classes, and drawing up articles and the like. One example of a rule for the acquisition of credits regarding the aforesaid education management system according to the present embodiment is shown in the following Table 1.

TABLE 1

| | Rate of the minimum number of credits by items | | | | |
|---|---|---|---|---|---|
| | which should be acquired with regard to the | | | | |
| Department | number of credits for graduation (140 credits) | | | | |
| A | 60% | 0~10% | 0~10% | 0~10% | 20% |
| B | 70% | 0~10% | 0~10% | 0~10% | 15% |
| C | 80% | 0~5% | 0~5% | 0~5% | 10% |
| D | 85% | 0~5% | 0~5% | 0~5% | 10% |
| E | 75% | 0~5% | 0~5% | 0~5% | 15% |

In Table 1, when talents and careers are admitted, the education management system may be implemented such that a condition for the granting of a degree is set as a case in which all the credits resulting from the recognition of talents and careers are at least more than 30% of the credits for graduation. Also, the education management system may record in a relevant student's database a degree authenticated with regard to only an item (talent or career) in which more credits are obtained when credits resulting from talent or career authentication are beyond a level of the minimum number of credits which are necessarily completed, and one kind of credits of the credits resulting from talent or career authentication is less than 30% of the number of credits for graduation.

In the education management system according to the present embodiment, among credits for graduation (for example, 140 credits), when a student who has obtained credits being beyond constant credits and based on credits obtained by the recognition of his or her talents or careers, a degree granted for the student may be recorded in a form such as ‘a bachelor of electronic engineering (the recognition of careers),’ ‘a bachelor of electronic engineering resulting from the recognition of careers,’ ‘a master of electronic engineering resulting from the recognition of careers,’ ‘a master of electronic engineering (the design of a semiconductor) (the recognition of careers)’ and the like.

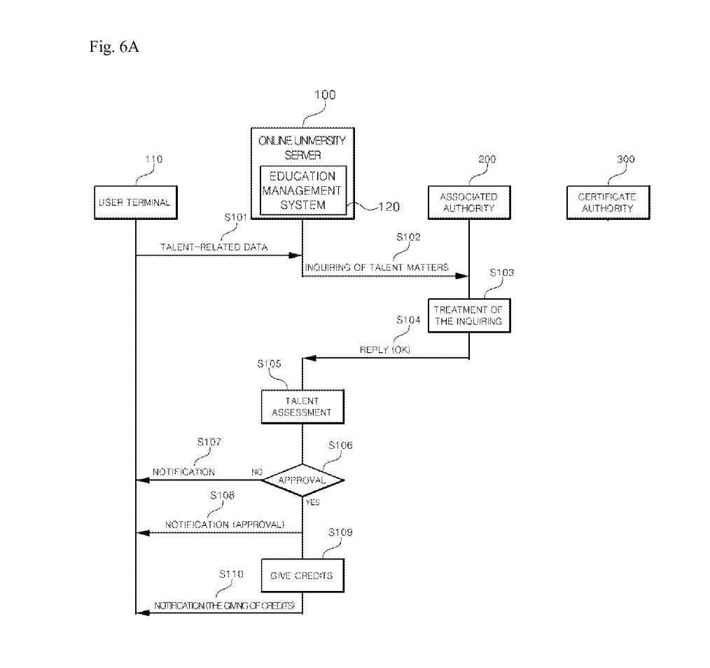

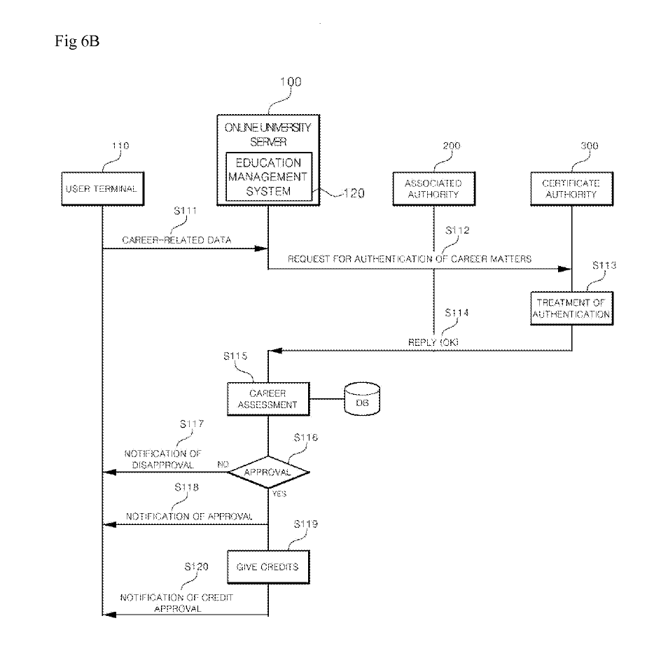

FIG. 6A and FIG. 6B are flow charts showing an education management method which can be applied to the education management system of FIG. 5.

Referring to FIG. 6A, in the education management method according to the present embodiment, first, the education management system 120 in the online university or graduate school or offline university or graduate school server 100 receives the student's talent-related data from the user terminal 110 S101.

Next, the education management system 120 inquires to the associated authority 130 as to whether or not the talent matters included in the talent-related data are true S102. Furthermore, after inquiring it to the associated authority 130 S103, the education management system 120 receives from the associated authority 130 a reply as to whether or not the talent matters are true S104.

Next, the education management system 120 evaluates the talent matters on the basis of the predetermined standards S105. After the assessing of the talent matters (S106), when the talent matters are not admitted, the education management system 120 transmits a notification about disapproval of the talent matters to the user terminal 110 S107. Meanwhile, when the talent matters are admitted, the education management system transmits a notification about approval of the talent matters to the user terminal 110 S108.

Next, the education management system 120 gives credits corresponding to a score resulting from the assessment of the talent matters for the student's major S109. Furthermore, the education management system 120 transmits a notification signal about the credits to the user terminal 110 through a short message service (SMS) or a multimedia message service (MMS). S110.

Meanwhile, the education management system for implementing the education management method according to the present embodiment may perform education management procedures for enabling credits based on careers S111 to S120, namely, for admitting a student's careers as credits, before, after or at the same time as performing the aforesaid education management procedures for enabling credits based on talents S101 to S110.

Referring to FIG. 6B, in the education management method according to the present embodiment, first, the education management system 120, which is mounted to or linked with the school server 100 such as a university or a graduate school, receives the student's career data from the user terminal S111.

Next, the education management system 120 assesses the career matters in the career data on the basis of the predetermined standards S115.

Meanwhile, in the education management system 120, confirming career matters and performing a notification on the career matters which are carried out before and after performing career assessment are substantially identical to the procedures described in the sections relating to FIG. 2, namely, S112 to S114, and S116 to S120), and thus the detailed description thereon will be omitted.

According to the present embodiment, the education management system 120 may provide predetermined credits for talent donation hours registered in the associated authority upon providing credits or may provide as the predetermined credits for business hours included in career matters being beyond a predetermined standard relating to a major-related business and performed in a company or completion hours of education being beyond a predetermined standard and performed in a pre-designated educational institution.

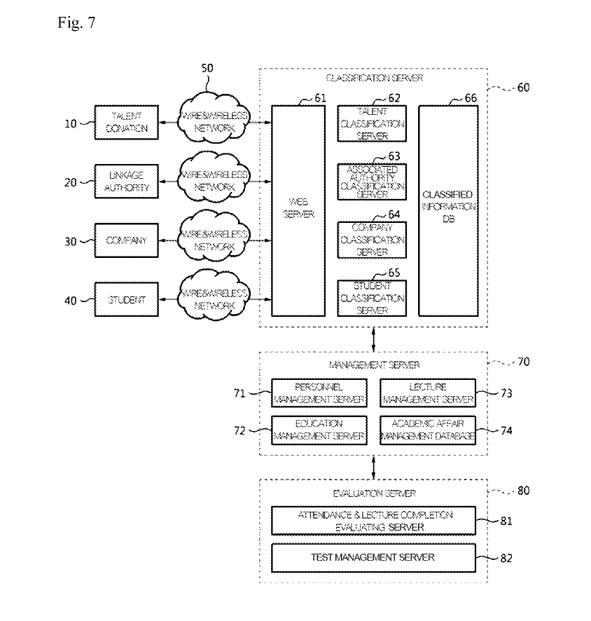

FIG. 7 is a block diagram showing an integrated education management system to which the education management system of FIG. 5 is applied.

Referring to FIG. 7, the integrated education management system according to the present embodiment may include: a classification server 60 provided so that the student 40 for performing the registration of talent donation 10 and the associated authority 20, and the registration of the company 30, and for being granted a degree can connect to the web server 61 through the wire and wireless network 50; a management server 70 linked with the classification server 60 so as to manage various of an online university; and an evaluation server 80 linked with the management server 70 and being in charge of the completion of classes and evaluation thereto.

The classification server 60 includes: the web server 61 provided so that a connector and the like can connect to an on-line university through the wire and wireless network; the talent classification server 61; the associated authority classification server 62, the company classification server 63; the school classification server 64; and the classified information DB 66 provided to record and store classified information of the talent classification server 61, the associated authority classification server 62, the company classification server 63 and the school classification server 64.

When individuals (registered students, non-registered students and the like) having various kinds of professional knowledge donate their talents to an online university or connect to request their talents as credits, the talent classification server 62 is provided to evaluate and classify the talents and to select appropriate lecture types. The associated authority classification server 63 is linked with the online university and is provided to select or evaluate the classification of an associated authority and the type of lectures, or transmit and receive linked data in the case of being connected by the authority in order to provide various kinds of professional knowledge or knowhow possessed by the authority through classes of the online university, or being linked for the authentication of talent matters or career matters. The company classification server 64 is provided to perform evaluation and classification when a company among various companies seeks a link between schools and industry so that a degree can be granted by linking various kinds of vocational education or research activity carried out in the company with the online university.

The student classification server 65 is provided to evaluate classification resulting from existence or non-existence of a connected student' career when the student has acquired a degree by taking the online university's classes and the like.

The above respective classification servers may be provided so that connectors can be individually evaluated and classified according to a program based on a standard for evaluation provided in each of the servers and the standard for evaluation, and may have a pop-up message so that a connector can receive information on personal matters or career matters as needed, or may have a means (a user interface and the like) which can display other input matters on a monitor and the like.

The management server 70 includes: a human resource management server 71 for managing a professor database, a school database, an educational personnel database and the like; an education management server 72 including a credit approval database, a paper database, and a career assessment database and the like; a lecture management server 73 including a course recording database, a video lecture database and the like; and an academic affair management database 74 including an online university situation database, a major completion-related database, a department information database and the like.

The management server 70 records, stores and manages data on lectures of an online university and general educational administration in a database, and at the same time, provides the information to an connector connected through the web server 61 by being linked with the classification server 60 and the evaluation server 80.

The evaluation server 80 includes an attendance and lecture completion evaluating server 81 configured to evaluate whether or not a participant of an online university has taken a video lecture, and a test management server 82 configured to manage results of various tests for measuring results according to taking of the lecture.

The evaluation server 80 is linked with the classification server 60 and the management server 70 and manages evaluation materials of a student connected through a web server 61.

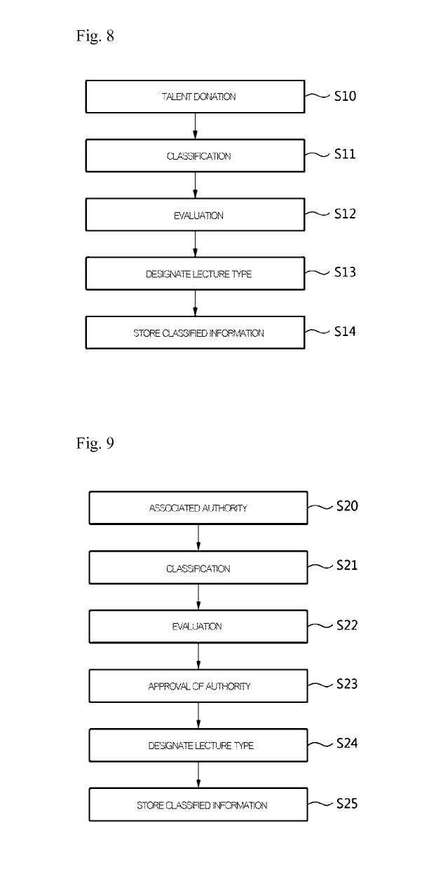

FIG. 8 is a flow chart showing an operation procedure of a talent classifying server of FIG. 7.

Referring to FIG. 8, when a connector connects to the talent classification server for talent donation, the talent classification server 62 classifies the talent and then classifies the types of lectures accordingly, thereby recording and storing information thereon in the classified information database 66. For this, the talent classification server 62 may be configured to carry out a series of procedures such as donating talents S10, classifying talents S11, evaluating the talents S12, designating lecture types S13, and storing classified information S14.

Here, the classifying of the talents S11 is a step of classifying information as to if the talents to be donated pertains to any department of the online university, and the evaluating of the talents S12 is a step of evaluating as to whether or not the donated talents is appropriate for education courses proceeded with departments provided at an online university, and a step of evaluating as to whether or not the donated talents correspond to the education courses necessary for the departments although they have a relation with the department. Also, the designating of the lecture type S13 is a step of determining if the talents are provided to attendees having any level after the talents have been admitted to be appropriate for the departments. For example, this is intended to determine a course for liberal arts or a mandatory course for major subjects and the like. Furthermore, the storing of the classified information S14 is a step of storing information on the classification and evaluation of the donated talents determined according to each step, and the designation of the lecture type in the classified information database 66.

FIG. 9 is a flow chart showing an operation procedure of a sorting server of a relevant authority of FIG. 7.

Referring to FIG. 9, when an expert group, such as an association connects in order to provide an online university with knowledge or knowhow belonging to their group, the associated authority classification server 63 classes information on the expert group, and then classifies the type of lectures accordingly, thereby recording and storing information thereon in the classified information database 66. For this, the associated authority classification server 63 performs a series of procedures such as connecting to the associated authority S20, classifying S21, evaluating S22, approval of an authority S23, designating a lecture type S24, and storing the classified information S25.

Here, the classifying S21 is a step of classifying information as to if the expert group belongs to any department of the online university when the expert group, such as an association connects in order to provide the online university with knowledge or knowhow belonging to the group.

The evaluating S22 is a step of evaluating as to whether or not the knowledge or knowhow belonging to the expert group, such as an association is appropriate for an educational course which is performed by a department provided with the online university, and of evaluating as to whether or not the knowledge or knowhow corresponds to an educational course which is required in the department.

The approval of the authority S23 is a step of approving so that the authority can teach at the online university only when ideology pursued by the associated authority having department suitability such as an association is appropriate for that pursued by the online university, and of preventing online education from being abused in a moneymaking purpose or in promotion and the like of the associated authority which is not suitable for the online university by providing of the knowledge through the associated authority unlike the talent donation of individuals.

The designating of the lecture type S24 is a step of determining as to if the knowledge or knowhow belonging to the expert group, such as the association is taken by attendees of any level after the department suitability has been admitted, for example, determining as to if the knowledge or knowhow is provided as a course for liberal arts or a mandatory course for major subjects.

The storing of the classified information S25 is a step of storing the information regarding the classification and evaluation of the associated authority which is a professional group such as an association determined according to each step above, and the designation of the lecture type in the classified information database 66.

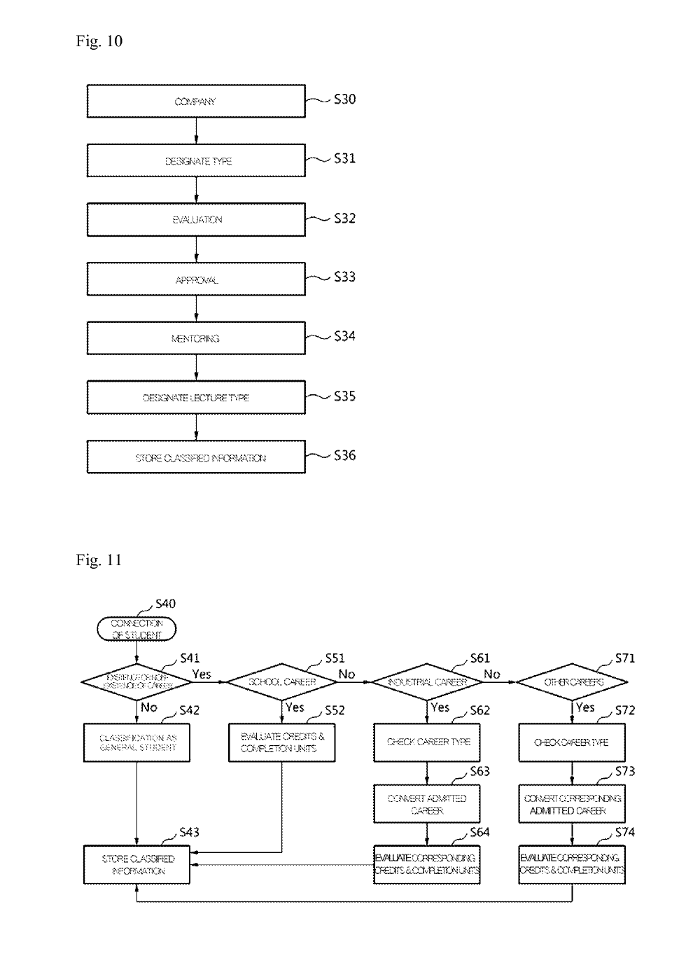

FIG. 10 is a flow chart showing an operation procedure of a company classification server of FIG. 7.

Referring to FIG. 10, when an online university connects in order to require the acquiring of a degree by being linking with job education or research activity carried out in a company, the company classification server 64 classifies information on the company and then classifies a lecture type accordingly, thereby recording and storing the information in the classified information database 66. For this, the company classification server 64 may be implemented to perform a series of procedures such as the company connecting to the server S30, designating a lecture type S31, performing evaluation S32, giving approval S33, performing mentoring S34, designating the lecture type S35 and storing the classified information S36.

Here, the designating of the lecture type S31 is a step of judging as to whether the company which connects for requiring the obtaining of a degree by being linked with job education or research activity of the company has an intention to grant a degree through liaison between the online university and industry or an intention to take a simple course for employees, and when the connection is intended to take the simple course for the employees, the lecture type is designated so that the employees can take the course as each student through individual connection. When research activity or job education of the company is performed by being linking with an online university, the company classification server 64 according to the present embodiment may be a server for processing it.

The performing of the evaluation S32 is a step of evaluating as to whether the job education or the research activity of the company is appropriate for a course of study carried out in each of the departments provided with the online university and a step of evaluating as to whether the job education or research activity corresponds to the course of study necessary for the department although it has a relation with the departments.

The giving of the approval S33 is a step of approving on-the-job education or a research activity of a company having suitability for a department to be taught through an online university when the on-the-job education or research activity is appropriate for pursuit of the online university, and to prevent online education from being misused in a moneymaking object or promotion which is not appropriate for the online university.

The performing of the mentoring S34 is a step in which, with respect to the company's job education or research activity, the company's senior members or superiors according to an organization structure of the company perform a role as professors, and subordinates or persons who carry out research according to instruction become attendees, thereby enabling education to be taken, and accordingly, when the company's senior members or superiors perform the role as the professors, in the similar way to that of the step of the talent donation (see S10 of FIG. 8), they give lectures based on official knowledge or knowledge resulting from the performance of researches, and the attendees take the lectures in the similar way to that of students acquire and obtain credits. For example, according to whether the lecture is taken or not, the performing of the mentoring S34 may include performing a student connection when there is a need to take a lecture and performing a connection for talent donation when there is no need to take a lecture, thereby enabling education according to the job education or research activity of the company to be performed through the online university. In such a case, it may be effective to implement a company own university within the online university through shared duties according to structures in the company unlike general students or talent donators of the online university.

The designating of the lecture type S35 is a step of determining if education according to the job education or research activity of the company is provided to attendees having any level. For example, this is intended to determine a course for liberal arts or a mandatory course for major subjects and the like. Furthermore, the storing of the classified information S36 is a step of storing information on the classification, evaluation, and designation of the lecture type of the company determined according to each step, and the designation of the lecture type in the classified information database 66.

FIG. 11 is a flow chart showing an operation procedure of a student classifying server of FIG. 7.

Referring to FIG. 11, the student classification server 65 carries out a series of procedures such as being connected by a student S40, judging as to whether or not careers are true S41, judging school careers S51, judging careers of an industry S61, and judging other careers S71. Here, the judging of the school careers S51 may include evaluating credits and the units of completion S52 and storing classified information S43. The judging of the careers of the industry S61 may further include checking a career type S62, converting the admitted careers S63, evaluating corresponding credits and the units of completion S64, and storing the classified information S43. Furthermore, the judging of other careers S71 may further include checking a career type S72, converting the admitted corresponding careers S73, evaluating the corresponding credits and the units of completion S74 and storing the classified information S43.

More specifically, when the connection of the student S40 has been performed, the student classification server 65 classifies the connected student as a general student S42 in a case where the student has no careers accumulated in other places except for a relevant school so that the student can be guided so as to take a lecture and take necessary credits according to the school's academic calendar.

Also, when the connected student has school careers accumulated in a different school other than a relevant school according to the present embodiment S51, the student classification server 65 enables credits completed in the different school and the unit of completion thereof to be evaluated as credits and the unit of completion recognized through the school sever according to the present embodiment S52, and guides the student to attend a course accordingly. In such a case, evaluation results of credits and a completion unit of the credits may be stored in the classified information database 66 through the step of storing classified information S43.

The step of judging industrial careers S61 may be performed by apprehending information relating to the kind of careers or the type of occupation accumulated in a different place other than the relevant school in a step of apprehending of the type of careers S62

When the connected student has industrial careers, information on the kind of careers or the type of occupation accumulated in the different place is apprehended through the step of apprehending the type of careers S62, and the careers are given a weighting according to the predetermined standards stored in the school server according to the present embodiment. The weighting to the careers may be evaluated as a corresponding credit and the unit of completion corresponding thereto and may be stored in the classified information database 66 through the step of storing classified information S43. According to the present embodiment, when a student has an industrial career, the completion of credits corresponding to the career is admitted, and thus there is no need to complete unnecessary credits, and a degree can be more easily granted, thereby promoting the reduction of school expenses and time.

In the step of judging other careers S71, when there are careers performed in a private business or one-person business place and the like, in the step of converting corresponding admitted career S73 after the step of checking the career type S72 intended to check the kind of careers and the type of occupation, the careers are converted into and provide with weighted values for the corresponding careers relating to other careers according to the prefixed standards in the school server according to the present embodiment. The weighted values for the careers are evaluated as credits and the units of completion corresponding thereto in the step of evaluating corresponding credits and the units of completion S74 and are then stored in the classified information database 66 in the step of storing classified information S43. According to the present embodiment, with regard to the career of a cottage industry or other special careers other than the careers of industrial enterprises, a level of the completion of credits is judged according to prefixed standards, and accordingly, a degree can be taken without a need to doubly complete the credits of an unnecessary area.

Table 2 is an example of a conversion table which can be applied to the step of career recognition conversion according to the present embodiment.

TABLE 2

| | | |
|---|---|---|
| Industrial career | Certificate of career | A |
| | Project performance career | B |
| | Certificate | C |
| | Award career | D |
| | Other career evidential matters | E |
| Other career | Business registration certificate | F |
| | Career field | G |
| | Certificate | H |
| | Group joining material | I |
| | Verification of achievements | J |

As shown in Table 2, in the step of converting the admitted careers S63 and the step of converting the admitted corresponding careers S74, with regard to the careers of an industry or other jobs, admitted career matters for respective items are prescribed, and weighted values for the respective items indicated as A to J are defined according to the respective prescribed items. Furthermore, the weighted values provided as defined may be provided as corresponding credits based on interrelationship with credits defined in the school server (the education management system) according to the present embodiment. According to the present embodiment, various careers accumulated through social activities may be admitted as proper credits and the like in n university or a graduate school so that the substantiality and virtual reality of education can be promoted.

In the aforesaid step of converting the admitted careers S63 and the step of converting the corresponding admitted careers S74, the matter that the student's career matters are admitted as credits for major subjects shows that the career matters are admitted as constant credits according to admitted career matters prescribed according to the respective items. Accordingly, as shown in Table 1, as the admitted career matters are prescribed according to the respective items, careers obtained through industrial enterprises or other jobs may be admitted as constant credits as prescribed. Except for the items indicated in Table 1, different items which can be admitted as careers may be added.

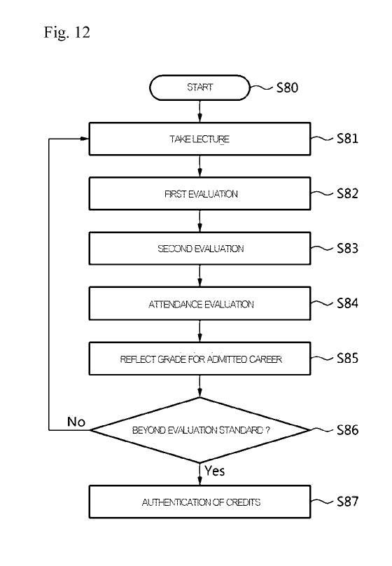

FIG. 12 is a flow chart showing an operation procedure of an evaluation server of FIG. 7.

Referring to FIG. 12, the evaluation server 80 evaluates an attendee who attends an online lecture through a web server 61 connected to the school server. To do so, the evaluation server 80 may be implemented so as to carry out a series of procedures of: attending the lecture S81, primarily evaluating the attendee S82, secondarily evaluating the attendee S83, evaluating attendance S84; reflecting grades for admitted careers S85; judging whether or not the grades is beyond evaluation standards S86; and authenticating credits S87.

In the step of attending the lecture S81, when respective participants take a lecture according to a guidance, and receive an evaluation, such as a first evaluation, a second evaluation and the like in the middle of the period of taking the lecture, the school server may reflect the participants' attendance matters or evaluation matters in their credits. In particular. unlike a general participant, in the case of a participant whose completion unit is determined according to the recognition of his or her career, the evaluation server 80 may reflect matters regarding the participant's completion unit S85, and may operate a total sum of grades resulting therefrom to be admitted as credits in a step of authenticating credits S87 when the total sum of the grades exceeds the predetermined evaluation standards.

Meanwhile, the aforesaid embodiments show the examples in which the present invention is applied to some jobs or businesses, but the present invention is not limited to the configurations, but can be applied to most of two million businesses. In such a case, according to the category of business, items which can be admitted as careers or talents are fixed and are then scored, and when a grade of talent matters or career matters intended to be admitted as credits is beyond a standard grade, some embodiments may be implemented so that credits corresponding thereto can be admitted. Here, a certificate, a grade being beyond a constant standard obtained through a certificate-related official test (a qualifying examination and the like), education completion hours performed in a designated organization, the period (month/year) of working in a relevant field, and the like may be applied to items which can be admitted as careers or talents.

According to some embodiments of the present invention, there may be generated the education management system and the education management method in an alternative university form that enable a student to skip education classes in a standard school and enable talents or careers to be admitted as credits, namely, credits for graduation of an university or a graduate school so that the student can receive a degree (for example, a talent-based degree, a career-based degree, and a talent and career-based degree).

Also, as set forth above, according to one embodiments of the present invention, there may be provided the education management system that is useful for development and effective utilization of human resources by enabling a student's talents or careers to be admitted.

According to another embodiment of the present invention, there may be provided the education management method that is useful for the development and effective utilization of human resources by enabling a student's talents or careers to be admitted as credits by going through a prescribed authentication procedure.

According to a further embodiment of the present, there may be provided the education management system that enables students to accumulate knowledge and obtain a degree regardless of a place to study by enabling the students to attend a lecture and acquire knowledge possessed by university professors at a desired place anywhere and anytime rather than a specific place. In other words, according to yet another embodiment of the present invention, there may be provided the education management system and method that enable careers except for school classes to be incorporated into a system for the completion of online education and to be linked with credits required for the obtaining of a degree by evaluating the careers pursuant to predetermined rules and authenticating the careers, which was not attempted in a conventional online or offline education system and method.

According to still another embodiment of the present invention, there may be provided the education management system and method that can be easily and variously approached by the people who do not enter university, need a degree, or would like to acquire a lot of knowledge, can be utilized as a space capable of satisfying the people's various cultural desires, can be a reference library where university or graduate school students can faithfully study, and can perform a role as a platform for initiating others into a person's talents and sharing knowledge.

According to still another embodiment of the present invention, there may be provided the education management system and method that enable various functional groups, such as associations existing in the society except for career assessment to participate in a teaching area, and enable the organizations of company units to participate in the teaching area and in courses as themselves, thereby allowing to take courses based on links between schools and industry.

According to still another embodiment of the present invention, there may be provided the education management system and an education management method that enable credits to be admitted on the basis of talents and careers in an alternative university form.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

1. An education management system which is connected to a user terminal via a network and which enables careers and talents to be admitted as credits, the system comprising:
a receiving unit configured to receive career data from the user terminal;
a career assessment unit configured to assess career matters included in the career data on the basis of predetermined standards; and
a credit-awarding unit configured to give credits corresponding to grades resulting from career assessment for a student's major to the career matters.

2. The system of claim 1, further comprising:
a certificate authority linkage unit configured to inquire to a relevant certificate authority as to whether or not the career matters included in the career data are true and to receive a reply as to whether or not the career matters are true from the relevant certificate authority.

3. An education management method for enabling credits to be admitted based on talents and careers, which is carried out by an education management system connected to a user terminal via a network, the method comprising:
receiving a student's career data from the user terminal;
assessing career matters included in the career data on the basis of predetermined standards; and
giving credits corresponding to grades resulting from the assessing of career matters for a student's major to the career matters when the career matters are admitted.

4. The method of claim 3, further comprising:
inquiring to a relevant certificate authority as to whether or not the career matters included in the career data are true before performing the career assessment; and
receiving a reply from the relevant certificate authority as to whether not the career matters are true.

5. An education management system which is connected to a user terminal via a network and which enables careers and talents to be admitted as credits, the system comprising:
a first receiving unit configured to receive a student's talent-related data from the user terminal;
an associated authority linkage unit configured to inquire to an associated authority as to whether or not talent matters included in the talent-related data are true and to receive a reply as to whether or not the talent matters are true from the associated authority;
a talent assessment unit configured to assess talent matters on the basis of predetermined standards; and
a credit-awarding unit configured to give credits corresponding to grades resulting from talent assessment for a student's major to the talent matters when the talent matters are admitted.

6. The system of claim 5, further comprising:
a second receiving unit configured to receive a student's career data from the user terminal;
a career assessment unit configured to assess career matters in the career data on the basis of predetermined standards; and
a credit-awarding unit configured to give credits corresponding to grades resulting from career assessment for the student's major to the career matters when the career matters are admitted.

7. The system of claim 6, further comprising:
a certificate authority linkage unit configured to inquire to a relevant certificate authority as to whether or not the career matters included in the career data are true and to receive a reply as to whether or not the career matters are true from the relevant certificate authority.

8. The system of claim 6, wherein the credit-awarding unit records in a relevant student's database that the relevant student can obtain a degree based on credits resulting from a recognition of talents, credits resulting from a recognition of careers, or credits resulting from a recognition of both talents and careers when the credits obtained from at least one of the talent assessment and the career assessment are standard credits or more than 60% of credits for graduation.

9. An education management method for enabling credits to be admitted based on talents and careers, which is carried out by an education management system connected to a user terminal via a network, the method comprising:
receiving a student's talent-related data from the user terminal;
inquiring to an associated authority as to whether or not talent matters included in the talent-related data are true;
receiving a reply from the associated authority as to whether not the talent matters are true;
assessing the talent matters on the basis of predetermined standards; and
giving credits corresponding to grades resulting from the talent assessment for a student's major to the talent matters when the talent matters are admitted.

10. The method of claim 9, further comprising:
receiving a student's career data from the user terminal;
assessing career matters included in the career data on the basis of predetermined standards; and
giving credits corresponding to grades resulting from the career assessment for the student's major to career matters when the career matters are admitted.

11. The method of claim 10, further comprising:
inquiring to a predetermined certificate authority as to whether or not the career matters included in the career data are true before performing the assessing of the career matters; and
receiving a reply from the predetermined certificate authority as to whether not the career matters are true, which is performed before the assessing of the career matters.

12. The method of claim 10, wherein the giving of the credits comprises recording in a relevant student's database that the relevant student can obtain a degree based on credits resulting from a recognition of talents, credits resulting from a recognition of careers, or credits resulting from a recognition of both talents and careers when credits obtained from at least one of the talent assessment and the career assessment are standard credits or more than 60% of credits for graduation.
